(19) United States
(12) Patent Application Publication
(10) Pub. No.: US 2006/0080127 A1
(43) Pub. Date: Apr. 13, 2006

(54) Buyer listing service and method of use

(76) Inventor: Sean Anthony Barry, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/232,537

(22) Filed: Sep. 22, 2005

Related U.S. Application Data
(60) Provisional application No. 60/612,628, filed on Sep. 23, 2004.

(51) Int. Cl. G06Q 99/00

(52) U.S. Cl. 705/1

(57) ABSTRACT

A method of using a buyer listing service (BLS) includes receiving buyer profile data of a prospective residential real estate buyer; storing the buyer profile data to a BLS database; receiving prospective residential real estate sales data to a residential real estate sales database; receiving a search query for buyer profile data in the BLS database that matches residential real estate sales data; and supplying buyer profile data from the BLS database that matches residential real estate sales data searched as a result of the search query.

### CROSS-REFERENCE TO RELATED APPLICATIONS

This application claims the benefit under 35 U.S.C. 119 of prior provisional patent application 60/612,628 filed on Sep. 23, 2004. The drawings and disclosure of prior provisional patent application 60/612,628 are hereby incorporated by reference as though set forth in full.

### FIELD OF THE INVENTION

The present invention relates, in general, to real estate listing services where real estate property criteria are listed and searched, and, in particular, to real estate listing services where buyer criteria are listed and searched.

### BACKGROUND OF THE INVENTION

The Multiple Listing Service (“MLS”) is a private real estate listing service where real estate property information is listed and searched by participating members (e.g., real estate agents). The MLS is designed to be a searching tool for agents to locate homes for their buyers. A problem with the MLS recognized by the present inventor is that it does not include information on potential buyers, which seller agents could search to help find potential buyers for a real estate listing.

### BRIEF DESCRIPTION OF THE DRAWINGS

FIG. 1 is flow chart of an exemplary method of using an embodiment of a buyer listing service.

FIG. 2 is a front elevational view of an embodiment of a buyer profile form for use in obtaining buyer profile information in the method illustrated in FIG. 1.

FIG. 3 is a chart of an exemplary method for performing prequalification of a buyer for the buyer listing service.

FIG. 4 is a block diagram of an exemplary system for implementing the buyer listing service method illustrated in FIG. 1.

FIG. 5 is a block diagram illustrating an exemplary computer as may be used in connection with the embodiments described herein.

### SUMMARY OF THE INVENTION

An aspect of the invention involves a method of using a buyer listing service (BLS). The method includes receiving buyer profile data of a prospective residential real estate buyer; storing the buyer profile data to a BLS database; receiving prospective residential real estate sales data to a residential real estate sales database; receiving a search query for buyer profile data in the BLS database that matches residential real estate sales data; and supplying buyer profile data from the BLS database that matches residential real estate sales data searched as a result of the search query.

Other, more particular features and advantages of the inventions are set forth in the following detailed description and drawings.

### DETAILED DESCRIPTION OF PREFERRED EMBODIMENTS

An embodiment of a Buyer Listing Service (“BLS™”) and method of using the same will be described. The BLS is a password encrypted, web-based subscription service that provides its members with a database of numerous prospective home buyer profiles. The purpose of the database is to enable agents to advertise their home buyers' needs (or buyers to advertise their home buyers' needs) to seller agents. This may be performed without revealing the identity of the home buyers to other agents and without jeopardizing the exclusive representation of buyers by the buyer agent. By advertising a home buyer's needs to all other seller agents, numerous seller agents can help determine whether a buyer's preferences match up with one of their property listings, and can assist in finding a suitable property for the buyer. Seller agents will be able to contact buyer agents (or buyers directly) with the “inside information” regarding their existing property listings, new properties coming on the market, and pocket listings.

At any given time, there are numerous properties that are not formally “on the market” yet the owners have a desire or need to sell the property in the near future. There may be any reason driving the sale (e.g., an impending divorce, job relocation, reduction in family size). These types of properties are referred to as “pocket listings” since they are generally not known by the market to be for sale. The problem for an agent with a pocket listing is that it is difficult to exploit such information since there is no listing agreement in place. Accordingly, if another agent finds out about the pocket listing, the other agent may go directly to the owner and solicit the sale. As a result, an agent with pocket listings must maintain the secrecy of the pocket listings to prevent other agents from going direct to the owner and selling the property. The BLS and method allow an agent to realize the benefit of the agent's pocket listings. By knowing the needs of the agents' home buyers (or home buyers), an agent can search and identify home buyers for the agent's pocket listings without ever revealing any property information. By accessing pocket listings, the BLS and method increase the likelihood that a buyer agent will find the right property for his home-buyer clients and thereby close more sales (or the home buyer will find the right property).

The buyer-information sharing platform of the BLS and method allow a buyer agent (or home buyer) to draw upon market knowledge and resources of all member agents to find a home for a buyer rather than simply relying on only the individual knowledge and resources of the buyer agent (or buyer).

For member seller agents, the BLS and method enable the seller agent to readily identify the agents who represent buyers (or buyers) whose preferences match up with the seller agent's property listings. The BLS and method allow the member seller agents to search the buyer database by at least 1) desired area(s), and 2) desired price range. In alternative embodiments of the BLS, one more additional and/or different buyers data items may be searched in the buyer database. Once a seller agent has identified a potential buyer for a listing, the seller agent may view the buyer's profile, which provides a variety of information specific to the buyer (e.g., timeframe of purchase such as, but not limited to, 30, 60, or 90 days, whether the buyer is a contingent buyer who must sell an existing residence as a condition to purchase, desired property amenities such a, but not limited to, style of home, school district, view information, acreage).

An additional aspect involves a method entitled the “MatchMaker™.” This method involves automatically searching and identifying in the BLS database all of the buyers whose preferences match up with each property listing of a seller agent. The moment a new buyer matches up with one of the seller agent's existing property listings, BLS instantly sends a communication (e.g., email, instant message, phone call, or some combination of these or other communications) to the seller agent with the buyer's housing preferences and the representing agent's contact information. This allows the seller agent to instantly identify those buyers whose preferences match up with the seller agent's property listings. The seller agent can then contact the listed buyer agents for the buyers (or buyers directly) and provide them with valuable information regarding the seller agent's properties. This aspect saves the seller agent valuable time and ensures that the seller agent is not missing any potential buyers for the seller agent's property listings.

Another aspect involves a method entitled “BuyerTracking™” for tracking the effectiveness of the seller agent's marketing. BLS performs this method by tracking the outcome of each buyer that is entered into its database thereby allowing the seller agent to track the effectiveness of the seller agent's marketing of a particular property listing. This method lets the seller agent know whether a buyer that has been matched up with one of the seller agent's property listings went on to purchase another property; hence, the seller agent will be able to determine whether matched-up buyers are passing on a particular property listing and allow the seller to adjust the marketing accordingly. Having access to such definitive information helps the seller agent determine (and show the seller client) that a particular property is overpriced. Once buyers have purchased a property, they are removed from the BLS database. While the property sale is pending, the buyer may remain in the BLS database, but may be listed as pending or inactive.

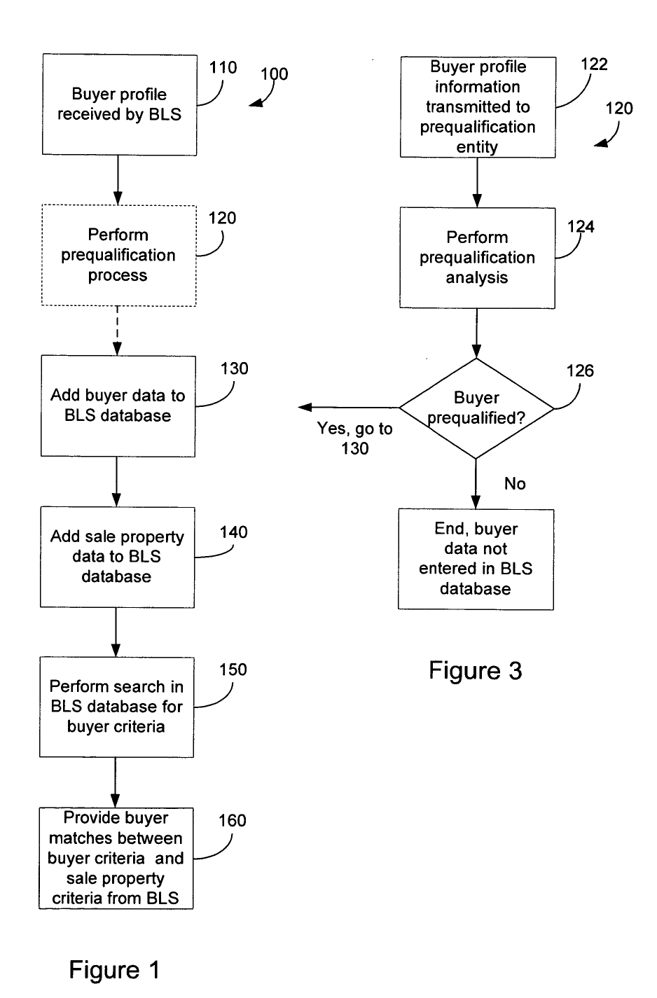

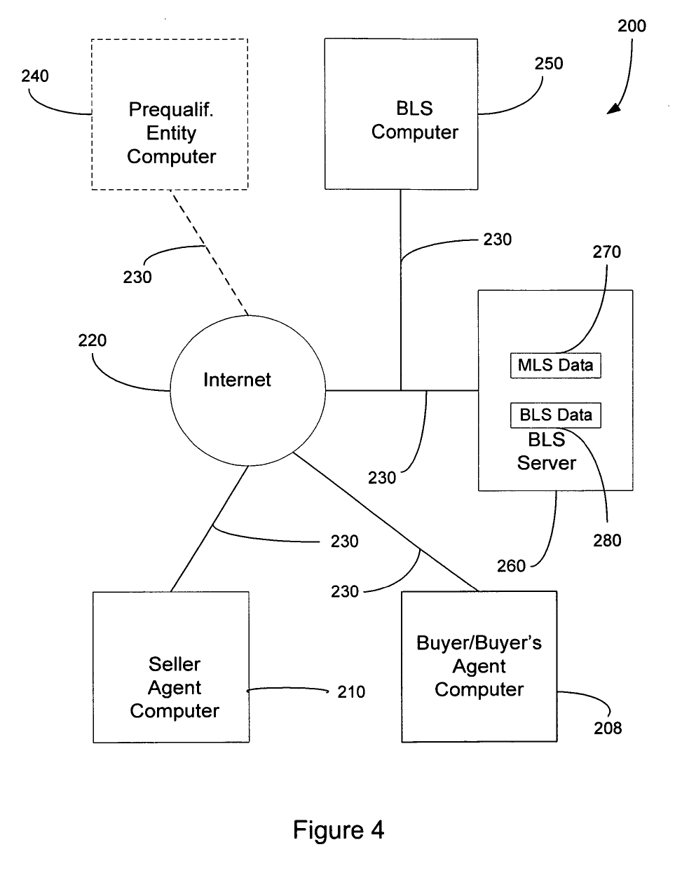

With reference to FIG. 1, an exemplary BLS method 100 will be described. A real estate agent representing a buyer fills out (or the buyer fills out) the exemplary Buyer Profile Form illustrated in FIG. 2 or another buyer profile. Preferably, the Buyer Profile Form is a web page where the buyer's agent (or the buyer) provides the requested input online for input into the BLS database 280 (FIG. 4). The Buyer Profile Form may have two sections, as shown, or in alternative embodiments, may have additional/different sections for inputting additional/different buyer data. Section I includes confidential buyer information (e.g., buyer name, address, contact info, whether the buyer is working with other agents, whether the agent has agreed to a buyer/broker agreement). This information is kept confidential and is only accessible by the buyer's agent and authorized personnel of the BLS provider. Section II includes buyer criteria (e.g., desired price range, desired area, whether purchase is contingent on sale of house, other remarks). The desired price range and desired area are the two most relevant criteria in this Section of the Buyer Profile Form because this information, among possible additional information (e.g., whether purchase is contingent on sale of house, other remarks), is searched in the BLS database. At step 110, the buyer agent (or buyer) provides the buyer profile form to the BLS provider. The form may be faxed to the BLS provider, emailed to the BLS provider, provided online via, for example, a BLS website, or by other methods. Thus, buyers in the general public, not just buyer agents, may submit the buyer profile information to the BLS provider for storage in the BLS database 280 (FIG. 4).

Next, at step 120, an optional prequalification process is performed on the buyer. A prequalification process helps to ensure that serious, financially able buyers are in the BLS database to ensure the integrity and reliability of the buyers in the database. The prequalification standards are provided by the BLS provider and are uniform.

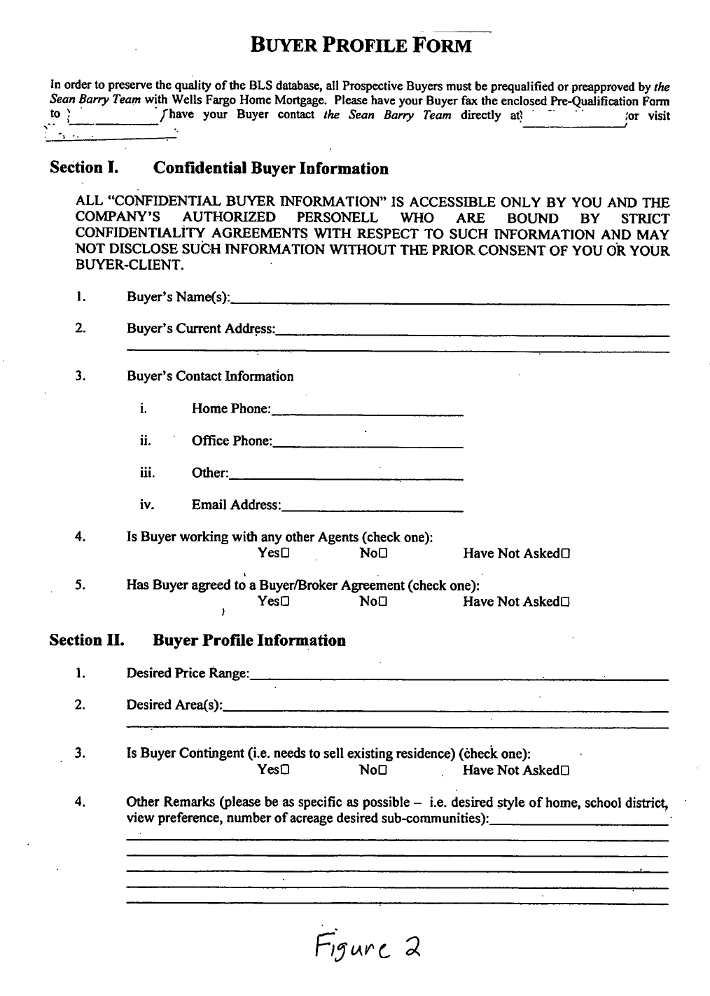

With reference to FIG. 3, the optional prequalification process 120 may include, at step 122, transmitting the buyer profile information obtained from the form to a prequalification entity. The prequalification entity may be the BLS provider, a sub-entity of the BLS provider, or may be a separate entity authorized to perform the prequalification process. The BLS provider may assign a separate prequalification entity (e.g., local mortgage agent) for each geographical region. The prequalification entity preferably resides in or near the region assigned and has exclusivity for performing the prequalification process for that region. The buyer profile information is transmitted to the prequalification entity assigned to cover the desired area(s) indicated in the buyer profile form. In an embodiment where the prequalification entity is a local mortgage agent, the local mortgage agent may pay the BLS provider for exclusively performing the prequalification process (e.g., a certain amount per month or year, or per prequalification process) for that region because performing the prequalification process will generate potential mortgage leads for the local mortgage agent.

At step 124, the prequalification analysis is performed by the prequalification entity for the amount indicated in the desired price range in the buyer profile form. The prequalification analysis may require additional information from the buyer (e.g., social security number, annual income, etc.), which may be requested by the prequalification entity or BLS provider. At step 126, a prequalification determination is made. If the buyer is prequalified, the buyer's data is added to the BLS database. If the buyer is not prequalified, the buyer's data is not added to the BLS database and the buyer's agent may be notified. The prequalification determination may included a determination of what price range the buyer would be prequalified for in the event the buyer does not prequalify for the desired price range indicated. The buyer's agent may resubmit the Buyer Profile Form with a lower desired price range in the event the buyer is not prequalified for the initial desired price range. In another embodiment or implementation of the invention, the buyer or the buyer's agent may perform a simple prequalification process, preferably to standards set by the BLS provider, to find out the buyer's upper limit and then submit the buyer profile to the prequalification entity or BLS provider so that the buyer does not feel rejected if prequalification of a higher amount is denied.

At step 140, which may be performed periodically (e.g., once a day, twice a day, frequently), the latest sale property data is downloaded from a MLS database to a property database of one or more servers of the BLS provider.

At step 150, one or more searches are performed for buyer criteria that match seller agents' property criteria. This may be performed manually by the member seller agents from their computers. The seller agent may log onto a BLS website, enter a username and password, and perform one or more search queries. Searching may be performed automatically in, for example, the above-described “MatchMaker” method.

In an exemplary implementation of the “Matchmaker” method, each MLS listing of an agent's is translated into a BLS query. For example, but not by way of limitation, the price field and the zip code field of the MLS listing may be translated into a query that includes a price (or price parameters) and a location/zip code for searching the BLS database for buyers that have a price (or upper price range) and zip code that match the parameters of the BLS query. Separate BLS queries are automatically performed for each MLS property listing of the agent's in the BLS database to determine if there is a buyer (or buyers) that matches the MLS listing. The results of the separate queries may be stored in a separate storage area to make comparisons.

At step 160, the seller agent is notified (e.g., via email, instant message, phone call, or some combination of these or other communications) of buyer matches for the selling agent's property listings.

FIG. 4 is a block diagram of an exemplary system 200 for implementing the BLS and method. As indicated above, the BLS and method 100 are preferably web-based. Buyers and/or buyer agents preferably access the BLS through buyer/buyer's agent computers 208, which connect to the Internet 220 via communication interface 230. Seller agents preferably access the BLS through seller agent computers 210. The seller agent computers 210 may be any type of computer device that provides seller agents with access to the BLS, such as, but not by way of limitation, a laptop computer, a desktop computer, a hand-held computer, an internet phone, a wireless communication device (e.g., Blackberry), a PDA, and a PDA/cell phone just to name a few. The seller agent computer 210 connects to the Internet 220 to access the BLS via communication interface 230. In alternative embodiments, other types of networks other than the Internet may be used to access the BLS. In an embodiment of the invention where the optional buyer prequalification process exists, one or more prequalification entity computers 240 may be connected to the BLS and/or one or more computers/servers of the BLS provider via the Internet 220 for transmitting prequalification information between the computer(s) 240 and the BLS and/or one or more computers/servers of the BLS provider. One or more BLS computers 250 may be connected to the BLS and/or one or more computers/servers of the BLS provider via the Internet 220 for transmitting BLS information between the computer(s) 250 and the BLS and/or one or more computers/servers of the BLS provider. One or more BLS computer servers 260 are connected to the Internet 220.

The server(s) 260 include a BLS database (“BLS data”) 280, which includes numerous home buyer profiles. Each buyer profile contains a set format of uniform information about the buyer such as, but not limited to, desired price range, area, time frame of purchase, whether the buyer is “contingent”, and remarks/comments provided by the representing agent. The identities and contact information of each buyer is confidential and only viewable by the representing agent and BLS. An agent with a seller agent computer 210 may search the buyer database 280 by any combination of at least 1) desired price range, and 2) desired area.

The server(s) 260 include a residential real estate sales database (“MLS data”) 270 that is downloaded from the MLS on a periodic basis (e.g., daily, twice a day, frequently). This dual database structure allows buyer profiles to automatically be matched up with MLS property listings based on price range and area. Through the “Matchmaker” method, prospective home buyers are automatically searched and matched up with each member agent's MLS property listings. The “Matchmaker” method allows seller agents to proactively market their property listings by readily identifying prospective home buyers for that agent's property listings.

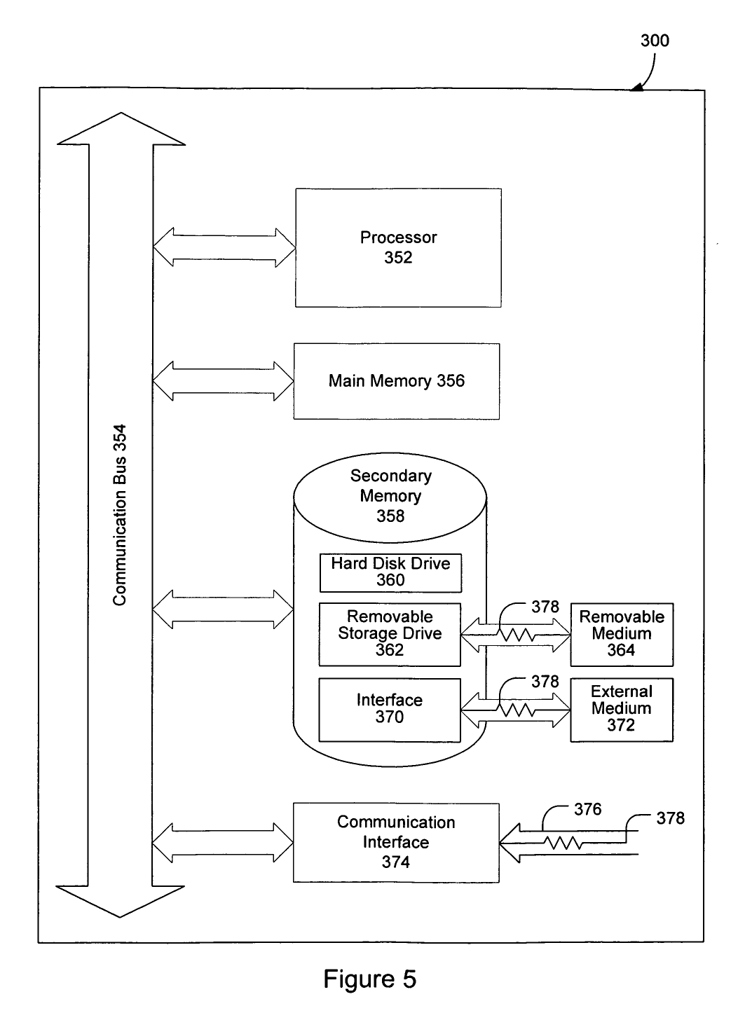

FIG. 5 is a block diagram illustrating an exemplary computer 300 as may be used in connection with the computers and servers described above. However, other computers and/or architectures may be used, as will be clear to those skilled in the art. Further, the description of many of the elements of the computer 300 described is applicable to the many of the elements described above.

The computer 300 preferably includes one or more processors, such as processor 352. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 352.

The processor 352 is preferably connected to a communication bus 354. The communication bus 354 may include a data channel for facilitating information transfer between storage and other peripheral components of the computer 300. The communication bus 354 further may provide a set of signals used for communication with the processor 352, including a data bus, address bus, and control bus (not shown). The communication bus 354 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer 300 preferably includes a main memory 356 and may also include a secondary memory 358. The main memory 356 provides storage of instructions and data for programs executing on the processor 352. The main memory 356 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 358 may optionally include a hard disk drive 360 and/or a removable storage drive 362, for example a floppy disk drive, a magnetic tape drive, a compact disc (“CD”) drive, a digital versatile disc (“DVD”) drive, etc. The removable storage drive 362 reads from and/or writes to a removable storage medium or removable memory device 364 in a well-known manner. Removable storage medium 364 may be, for example, a floppy disk, magnetic tape, CD, DVD, etc.

The removable storage medium 364 is preferably a computer readable medium having stored thereon computer executable code (i.e., software) and/or data. The computer software or data stored on the removable storage medium 364 is read into the computer 300 as electrical communication signals 378.

In alternative embodiments, secondary memory 358 may include other similar means for allowing computer programs or other data or instructions to be loaded into the computer 300. Such means may include, for example, an external storage medium 372 and an interface 370. Examples of external storage medium 372 may include an external hard disk drive or an external optical drive, or and external magneto-optical drive.

Other examples of secondary memory 358 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 372 and interfaces 370, which allow software and data to be transferred from the removable storage unit 372 to the computer 300.

Computer 300 may also include a communication interface 374. The communication interface 374 allows software and data to be transferred between computer 300 and external devices (e.g. printers), networks, or information sources. For example, computer software or executable code may be transferred to computer 300 from a network server via communication interface 374. Examples of communication interface 374 include a modem, a network interface card (“NIC”), a communications port, a PCMCIA slot and card, an infrared interface, and an IEEE 1394 fire-wire, just to name a few.

Communication interface 374 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/internet protocol (“TCP/IP”), serial line internet protocol/point to point protocol (“SLIP/PPP”), and so on, but may also implement customized or non-standard interface protocols as well.

Software and data transferred via communication interface 374 are generally in the form of electrical communication signals 378. These signals 378 are preferably provided to communication interface 374 via a communication channel 376. Communication channel 376 carries signals 378 and can be implemented using a variety of communication means including wire or cable, fiber optics, conventional phone line, cellular phone link, radio frequency (RF) link, or infrared link, just to name a few.

Computer executable code (i.e., computer programs or software) is stored in the main memory 356 and/or the secondary memory 358. Computer programs can also be received via communication interface 374 and stored in the main memory 356 and/or the secondary memory 358. Such computer programs, when executed, enable the computer 300 to perform the various functions of the present invention as previously described.

In this description, the term “computer readable medium” is used to refer to any media used to provide computer executable code (e.g., software and computer programs) to the computer 300. Examples of these media include main memory 356, secondary memory 358 (including hard disk drive 360, removable storage medium 364, and external storage medium 372), and any peripheral device communicatively coupled with communication interface 374 (including a network information server or other network device). These computer readable mediums are means for providing executable code, programming instructions, and software to the computer 300.

In an embodiment that is implemented using software, the software may be stored on a computer readable medium and loaded into computer 300 by way of removable storage drive 362, interface 370, or communication interface 374. In such an embodiment, the software is loaded into the computer 300 in the form of electrical communication signals 378. The software, when executed by the processor 352, preferably causes the processor 352 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Although this invention has been described in terms of certain preferred embodiments, other embodiments apparent to those of ordinary skill in the art are also within the scope of this invention. Accordingly, the scope of the invention is intended to be defined only by the claims that follow.

What is claimed is:

1. A method of using a buyer listing service (BLS), comprising:
receiving buyer profile data of a prospective residential real estate buyer;
storing the buyer profile data to a BLS database;
receiving prospective residential real estate sales data to a residential real estate sales database;
receiving a search query for buyer profile data in the BLS database that matches residential real estate sales data;
supplying buyer profile data from the BLS database that matches residential real estate sales data searched as a result of the search query.

2. The method of claim 1, wherein receiving buyer profile data includes receiving buyer profile data from at least a buyer and a buyer's agent via a webpage of a BLS website.

3. The method of claim 1, wherein storing the buyer profile data to a BLS database includes storing the buyer profile data in a BLS database on a BLS server.

4. The method of claim 1, wherein receiving prospective residential real estate sales data includes downloading residential real estate sales data from a multiple listing service (MLS) database to the residential real estate sales database.

5. The method of claim 1, wherein receiving a search query for buyer profile data includes receiving a manual search query for buyer profile data from a real estate sales agent.

6. The method of claim 1, wherein receiving a search query for buyer profile data includes receiving an automatic search query performed on a periodic basis for buyer profile data in the BLS database that matches residential real estate sales data in the residential real estate sales database.

7. The method of claim 1, wherein supplying buyer profile data includes supplying buyer profile data to a real estate sales agent.

8. The method of claim 1, further including tracking buying status information of a buyer profile in the BLS database, and supplying buying status information to a real estate sales agent that previously supplied buyer profile data that matched residential real estate sales data for the real estate sales agent.

9. The method of claim 1, wherein the buying status information includes information representing that the buyer has purchased another property and summary information on the property purchased.

10. The method of claim 1, further including performing a prequalification of the buyer corresponding to the buyer profile data prior to adding the buyer profile data for the buyer to the BLS database.
